(19) United States
(12) Patent Application Publication
(10) Pub. No.: US 2010/0028605 A1
(43) Pub. Date: Feb. 4, 2010

(54) SUBSTRATE FOR EPITAXIAL GROWTH

(76) Inventor: Yuichi OSHIMA, Tsuchiura-shi (JP)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/345,933

(22) Filed: Dec. 30, 2008

(30) Foreign Application Priority Data
Aug. 4, 2008 (JP) JP2008-200638

(51) Int. Cl. B32B 3/00

(52) U.S. Cl. 428/156

(57) ABSTRACT

A chamfering part is partially formed on the backside, opposite to the front side of a substrate on which epitaxial growth is performed. When a size of the substrate is set at x (mm), preferably length of the chamfering part applied to the backside of the substrate is set at 2 mm or more and 0.15x (mm) or less. In addition, when the substrate is placed on a flat surface, with the front side turned up, preferably height and depth of a gap formed between the substrate and the flat surface are set at 0.2 mm or more.

### BACKGROUND

1. Technical Field

The present invention relates to a substrate for epitaxial growth used as a ground substrate for epitaxial growth, for manufacturing an electronics device, etc, and particularly relates to the substrate for epitaxial growth that improves a chamfering part applied to the substrate.

2. Description of Related Art

An epitaxial growth technique is often used in a manufacturing process of an electronics device. For example, the epitaxial growth technique is used in a manufacture of an LSI of Si, and in a manufacture of a light emitting element using a GaAs related epitaxial wafer or a GaN related epitaxial wafer. The epitaxial growth in which a substrate and an epitaxial growth layer are made of the same material, such as growing Si on a Si substrate, is also called a homoepitaxy. Meanwhile, the epitaxial growth in which the substrate and the epitaxial growth layer are made of different materials is also called a heteroepitaxy. As a method of a crystal growth, various methods are used. Methods such as a VPE (Vapor Phase Epitaxy) and a MBE (molecular beam Epitaxy) and sputtering are given as typical methods.

Although various shapes are given for the substrate (ground substrate, wafer) for epitaxial growth, a circular or angular flat substrate is generally given. In a case of a single-crystal substrate, the substrate is sometimes marked with an orientation flat (OF) or an index flat (IF), to thereby clarify a crystal orientation and a front side/backside of the substrate. In a case of a large substrate, notch is sometimes formed instead of the OF and IF.

In addition, in the peripheral edge portion of the front side/backside of the substrate for epitaxial growth, chamfering work is applied over the whole periphery in many cases. Although there are several objects to apply chamfering to the substrate, one of them is to prevent chipping and cracking of the substrate. Further, another object is to prevent swelling (edge crown) of an outer peripheral part at the time of the crystal growth. Moreover, another object of applying chamfering to the backside of the substrate is to easily lift the substrate by tweezers and facilitate handling.

Conventionally, in order to easily identify the front side/backside of the substrate, there is a proposal that a chamfering method of the outer peripheral part of the substrate is devised, such as changing a chamfering shape between front side and backside, forming the notch having different angles between the front side and backside, changing a chamfering roughness between the front side and backside of the substrate, and changing uniformity of the chamfering roughness between the front side and backside of the substrate (for example, see patent documents 1 to 4).

### (Patent Document 1)

### Japanese Patent Laid Open Publication No. 2001-44084

(Patent document 2)

### Japanese Patent Laid Open Publication No. 2002-15966

(Patent document 3) Japanese Patent Laid Open Publication No. 2002-25873
(Patent document 4)

### Japanese Patent Laid Open Publication No. 2004-31642

### SUMMARY OF THE INVENTION

Incidentally, if a high quality epitaxial layer is obtained, a substrate front side must not be contaminated before growth. In order to prevent such a contamination, a work is performed in a clean room, and a worker wears a mask or gloves. However, even if such a measure is taken, the substrate front side is sill have an opportunity of being contaminated. This is caused by handling using the tweezers. When the substrate is taken out from a storage container and set in a crystal growth furnace, the peripheral edge portion of the substrate is clamped by the tweezers in many cases. In addition, the same thing can be said for each kind of inspection before epitaxial growth and the step of pre-processing. A part clamped by the tweezers is contaminated or scratched. The growth of the high quality epitaxial layer can not be expected in such a part. Abnormal growth occurs in this part in many cases. Thus, a device can not be formed in a part clamped by the tweezers, and this causes a degradation of a manufacturing yield.

As a measure to minimize damage by substrate contamination by the tweezers, a part clamped by the tweezers is designated. For example, it is so defined as a rule, that the right end of the orientation flat is clamped. However, this can not be regarded as a reliable method. Even if the part clamped by the tweezers is designated, a deviated position is clamped little by little every time it is clamped by the tweezers, thus enlarging a contaminated area of the substrate and a state, in which a place against the rule is accidentally clamped, occurs frequently.

An object of the present invention is to provide a substrate for epitaxial growth capable of tremendously suppressing an area contaminated by handling the substrate, and the present invention takes several aspects as follows.

According to one aspect of a substrate for epitaxial growth of the present invention, a chamfering part is partially formed on the backside opposite to the front side of the substrate for performing epitaxial growth.

In the substrate for epitaxial growth according to this aspect, preferably when a size of the substrate is set at x (mm), a peripheral length of a chamfering part applied to the backside of the substrate is set at 2 mm or more and 0.15x (mm) or less.

In addition, when the substrate is placed on a flat surface, with a substrate front side turned up, preferably a height of a gap is set at 0.2 mm or more, which is formed between the chamfering part on the backside of the substrate and the flat surface. Further, preferably a depth of the gap is set at 0.2 mm or more.

Further, it is preferable that marks are inscribed on both end-positions of the chamfering part on the backside, and these marks are preferably a notch or a laser mark.

According to another aspect of the substrate for epitaxial growth of the present invention, chamfering parts of two kinds or more of different shapes is formed on the backside, opposite to the front side of the substrate that performs epitaxial growth.

In the substrate for epitaxial growth according to the second aspects, when the substrate is placed on a flat surface, with the substrate front side turned up, one of the chamfering parts of two kinds or more of different shapes is a large chamfering part, a height of the gap set at 0.2 mm or more, which is formed between the substrate and the flat surface, and preferably a peripheral length of the large chamfering part is set at 2 mm or more and 0.15x (mm) or less, when a size of the substrate is set at x (mm).

Moreover, when the substrate is placed on the flat surface, with the substrate front side turned up, preferably both of the height and depth of the gap are set at under 0.1 mm, in a peripheral part other than the large chamfering part of the substrate.

In addition, it is preferable to inscribe the marks to the both end positions of the large chamfering part. The marks is preferably the notch or the laser mark.

According to another aspect of the substrate for epitaxial growth, an area having plural different chamfering shapes is formed in a peripheral direction of the substrate, on the backside opposite to the front side of the substrate that performs the epitaxial growth.

In the aforementioned substrate for epitaxial growth, preferably the area of plural different chamfering shapes includes a clamping area into which a clamping tool can be inserted for clamping the substrate from the gap formed between the substrate and the flat surface, and a non-clamping area into which the clamping tool is hardly inserted from this gap, when the substrate is placed on the flat surface, with the surface turned up.

Further, preferably the chamfering shape of the backside of the clamping area is formed, so that the height of the gap is set at 0.2 mm or more. Further, the chamfering shape on the backside of the clamping area is preferably formed, so that the depth of the gap is set at 0.2 mm or more.

In addition, the chamfering shape on the backside of the non-clamping area is preferably formed, so that the height and depth of the gap are set at under 0.1 mm.

Further, the length in the peripheral direction of the substrate of the clamping area is preferably set at 2 mm or more and 0.15x (mm) or less, when the diameter of the substrate is set at x (mm).

Moreover, preferably, the marks are inscribed to the both end-positions of the clamping area, with notch or laser marks.

As described above, according to this embodiment, the chamfering part of the backside that can be handled by the tweezers, etc, can be defined as an extremely limited one portion, and the area contaminated by handling of the substrate can be tremendously reduced. As a result, the area of the abnormal growth at the time of the epitaxial growth can be reduced, and the yield of the electronics device can be improved.

### BRIEF DESCRIPTION OF THE DRAWINGS

FIG. 1A is a plan view illustrating a wafer for epitaxial growth according to an example 1 of the present invention, viewed from the front side.

FIG. 1B is an expanded sectional view of the wafer end portion other than a part A of FIG. 1A.

FIG. 1C is an expanded sectional view of the wafer end portion of the part A of FIG. 1A.

FIG. 2A is a plan view illustrating a wafer for epitaxial growth according to an example 2 of the present invention, viewed from the front side.

FIG. 2B is an expanded sectional view of the wafer end portion of the part A of FIG. 2A.

FIG. 2C is an expanded sectional view of the wafer end portion of the part A of FIG. 2A.

FIG. 3A is a plan view illustrating a wafer for epitaxial growth according to an example 3 of the present invention, viewed from the front side.

FIG. 3B is an expanded sectional view of the wafer end portion other than the part A of FIG. 3A.

FIG. 3C is an expanded sectional view of the wafer end portion of the part A of FIG. 3A.

FIG. 4A is a plan view illustrating a wafer for epitaxial growth according to an example 4 of the present invention, viewed from the front side.

FIG. 4B is an expanded sectional view of the wafer end portion other than the part A of FIG. 4A.

FIG. 4C is an expanded sectional view of the wafer end portion of the part A of FIG. 4A.

FIG. 5A is a plan view illustrating a conventional wafer for epitaxial growth, viewed from the front side.

FIG. 5B is an expanded sectional view of an end portion of the wafer of FIG. 5A.

FIG. 6 is a view explaining a measurement area in abnormal growth measurement, when epitaxial growth is performed by using the wafer for epitaxial growth of examples and comparative examples.

FIG. 7 is a graph illustrating a result of an abnormal growth distribution in an abnormal growth measurement, when the epitaxial growth is performed by using the wafer for epitaxial growth of the examples and comparative examples.

FIG. 8 is a graph illustrating a relation between a diameter of the wafer and a tip end width of tweezers.

### BEST MODE FOR CARRYING OUT THE INVENTION

Preferred embodiments of a substrate for epitaxial growth according to the present invention will be described hereunder.

In the above-described conventional technique, an area with contamination and scratch is enlarged, by clamping the substrate using tweezers. This is because an operator's burden of attention is required eventually. For example, it can be considered that marks are inscribed to a place to clamp the substrate by the tweezers. However, this is also a method requiring the operator's burden of attention, and can not be regarded as sufficient.

Therefore, according to the embodiments described below, in order to overcome a problem that the operator's burden of attention is required, a chamfering part on the backside capable of performing substrate handling is defined in a specific place of a peripheral part of the substrate, and a clamping tool and a holding tool such as tweezers for handling the substrate are made not to be inserted to the backside of the substrate other than the specific place, so that the substrate can not be clamped even if so desired.

As described above, the chamfering part is defined, on the backside capable of handling the substrate. However, there are several elements in defining the chamfering part.

A peripheral length of the chamfering part on the backside, which is applied to the peripheral edge portion of the substrate, can be given as a first element.

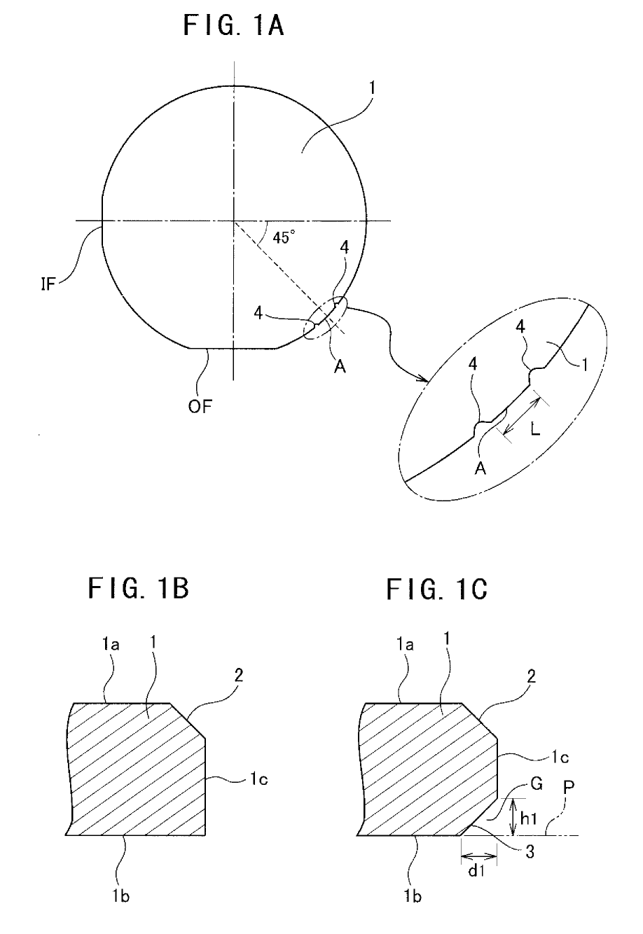

For example, in a round wafer 1 as shown in FIG. 1A to 1C, the length of a chamfering part A on the backside corresponds to a length L in a circumferential direction. When the length L of the chamfering part is too long, a contaminated area is eventually enlarged. Reversely, when it is too short, the tweezers are hardly inserted to the backside 1b of the wafer 1 on a flat surface P, thus inducing an error in handling.

Although there are various shapes and sizes of the tweezers, in a case of the tweezers generally used in handling of the substrate (wafer), the tip end thereof is formed into a flat shape. Although a tip end width of the tweezers is variously set, which one is appropriately used is approximately determined, depending on the diameter of the substrate. When the tip end width of the tweezers is too narrow, a force is locally concentrated when the substrate is lifted, thus inducing a risk of breakage. Meanwhile, when it is too wide, a clamping area becomes too large, thus inducing a large contaminated area.

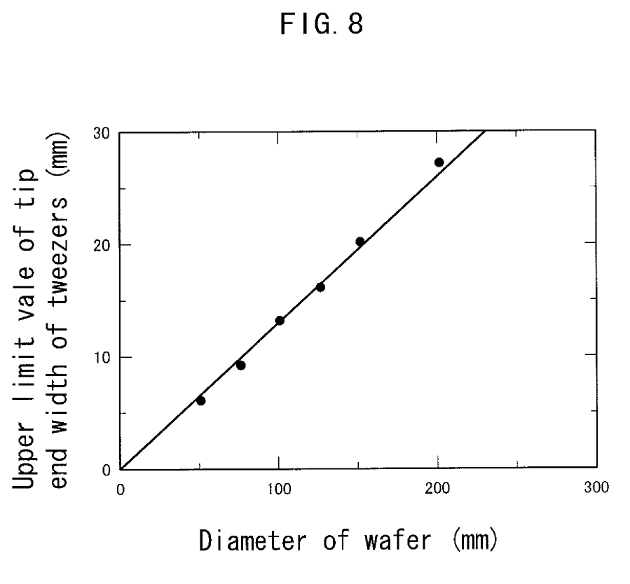

A relation between the size of the round substrate (wafer size) and an upper limit value of the tip end width of appropriate tweezers, which are frequently used, was examined. Then, it was found that there was a linear relation between them as shown in FIG. 8. When a diameter of the round substrate is set at x (mm) (the size in the case of an angular substrate corresponds to a vertical or lateral length), and the tip end width of the tweezers is set at y (mm), it is found that relation of x (mm) and y (mm) is expressed by y=0.13x. Accordingly, it is preferable that the upper limit value of the tip end width of the tweezers may be defined as y=0.15x, while giving a margin thereto. However, the tweezers, with the tip end width set at 1.5 mm, is not used, even if the substrate has 10 mm diameter. A lower limit size of the tweezers which can be generally obtained and suitable for use is set at about 2 mm. Thus, the peripheral length of the backside chamfering part of the substrate (large chamfering part and clamping area) A is set at 2 mm or more and 0.15x (mm) or less, the contamination of the substrate by clamping using the tweezers can be suppressed to minimum.

The shape/dimension and angle of the chamfering part on the backside is given as a second element.

Regarding the second element, although depending on the used tweezers, as shown in FIG. 1C first, when the wafer 1 is placed on the flat surface P, with a substrate front side 1a turned up, height h1 of the gap (opening) G between the backside 1b of the wafer 1 and the flat surface P must be set to be larger than the height (thickness) of the tip end of the tweezers. Usually, the thickness of the tip end of the flat tweezers is set at approximately 0.2 mm or more. Therefore, when the height h1 of the gap is set at 0.2 mm or more, the tweezers can be significantly easily inserted. However, this is not sufficient and the tweezers are not nicely slipped in. It is important that the chamfering part on the backside (large chamfering part and clamping area) A has a certain degree of angle (inclined angle) with respect to a vertical surface (end face 1c of the wafer 1). In other words, depth d1 is required for the gap G generated by formation of the chamfering part on the backside. When the depth d1 is set at 0.2 mm or more, the tweezers are smoothly inserted, making it possible to clamp and lift the wafer 1.

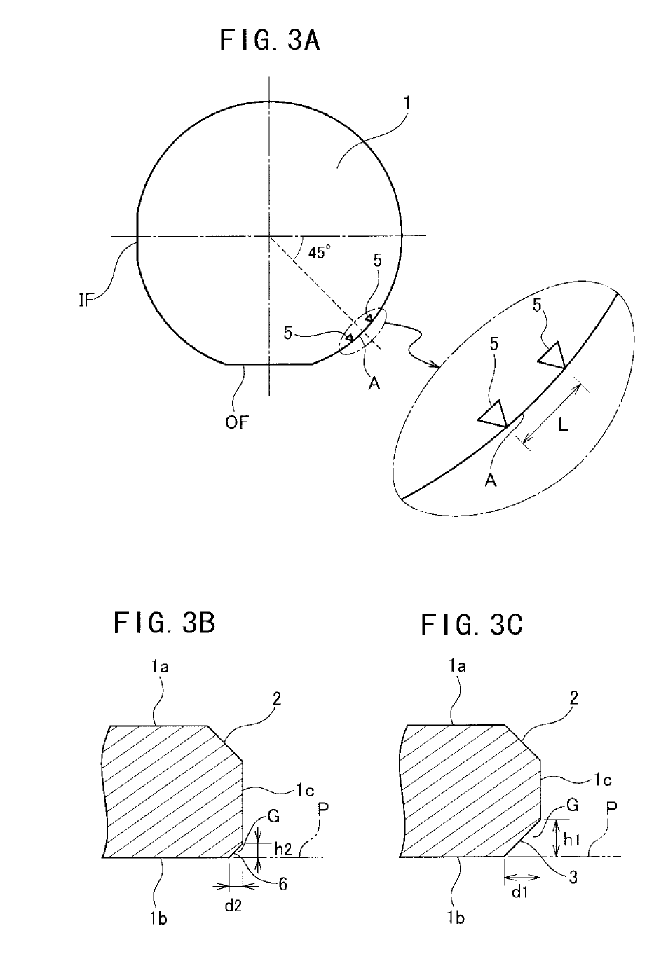

Meanwhile, regarding the chamfering on the backside of the substrate, in order to define the substrate contaminated area due to clamping by the tweezers, chamfering work is not applied to a part other than the chamfering part A on the backside so that the tweezers cannot be inserted (see FIG. 1B). Alternately, in order to suppress chipping and breakage of the substrate, even if the chamfering work is applied to a part other than the chamfering part A on the backside, the chamfering part allowing no tweezers to be inserted (small chamfering part and non clamping area) is formed (see FIG. 3B). Specifically, as shown in FIG. 3S, when the wafer 1 is placed on the flat surface P, with the substrate front side 1a turned up, height h2 of the gap (opening) G between the backside 1b of the wafer 1 and the flat surface P is set at under 0.1 mm, and depth d2 is set at under 0.1 mm. Whereby, the following effect is remarkably exhibited in a usually used tweezers. Namely, it is possible to prevent a state such as allowing the tweezers to slip in unconsciously from the gap.

The number of places to which the chamfering work is applied on the backside is given as a third element.

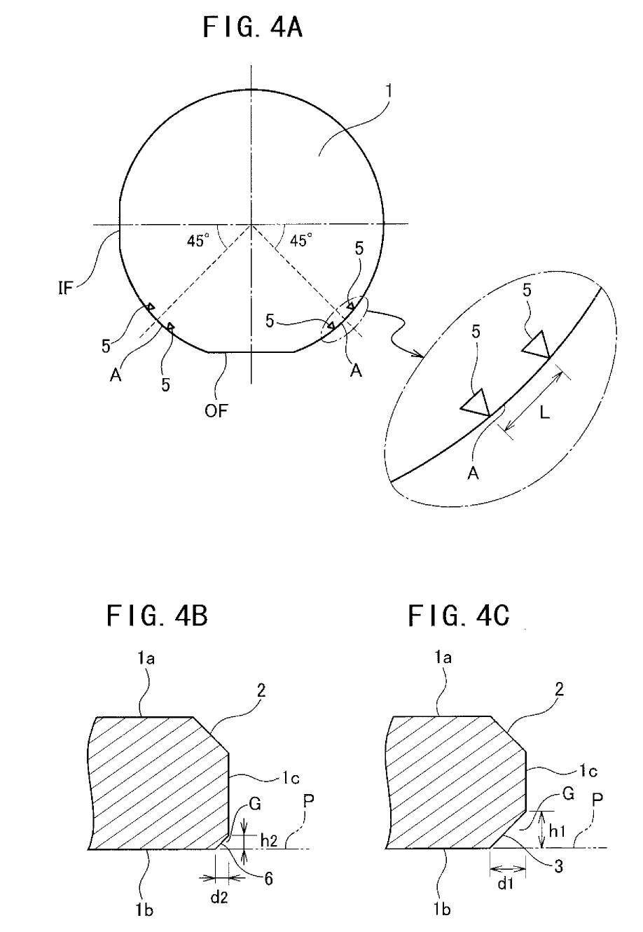

One place is most preferable, from the concept of making the contaminated place of the substrate to minimum. However, it is also probable that the chamfering part is applied to a plurality of places, in accordance with a condition of an individual process (see FIG. 4).

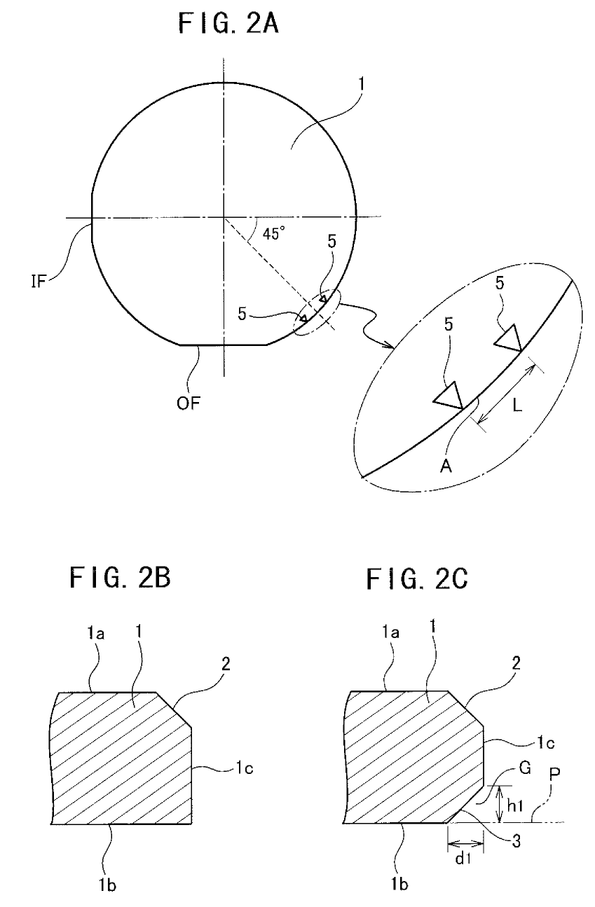

In addition, even if the chamfering part (large chamfering part and a clamping area) A on the backside, being a substrate clamping position using the tweezers is limited to extremely one portion on the peripheral edge part of the substrate, usability is not good unless this part is identified at a glance. Therefore, it is desirable to inscribed marks to both end-positions of the chamfering part (large chamfering part and clamping area) A on the backside, so as to be easily identified at a glance. As a specific means for marking, a method of curving a notch (see FIGS. 1A to 1C and FIGS. 3A to 3C), and a method of performing laser marking (see FIGS. 2A to 2C and FIGS. 4A to 4C) are given.

As described above, according to this embodiment, the chamfering part of the backside that can be handled by the tweezers, etc, can be defined as an extremely limited one portion, and the area contaminated by handling of the substrate can be tremendously reduced. As a result, the area of the abnormal growth at the time of the epitaxial growth can be reduced, and the yield of the electronics device can be improved.

### EXAMPLES

Next, examples of the present invention will be described hereunder.

### Example 1

An example 1 of the present invention will be described by using FIG. 1A to FIG. 1C.

FIG. 1A is a plan view of a wafer 1, being a substrate, viewed from the front side 1a; FIG. 1B is an expanded sectional view of a wafer end portion of a part other than a part A (part/area between notches 4 and 4) of the wafer 1 in FIG. 1A, and FIG. 1C is an expanded sectional view of the wafer end portion of the part A of the wafer 1 in FIG. 1A.

First, GaAs single crystal ingot with a diameter of 3.1 inch and a length of 250 mm was manufactured, by a crystal growth from a melt liquid. After the outer periphery of this ingot was ground to set the diameter at 3 inch, plan surface grinding was applied to a (0-1-1) surface, thus forming an orientation flat OF having a width of 22 mm. In addition, the plan surface grinding was also applied to a (0-11) surface, and an index flat IF having a width of 12 mm was formed. Further, after slicing the ingot by using a multi wire saw, both surfaces of the wafer were polished, to form a GaAs wafer 1 having a thickness of 650 μm, in which a (100) surface was set as a main surface.

Subsequently, by using a chamfering machine, chamfering grinding was applied to the edge part on the front side 1a of this GaAs wafer 1 over the whole periphery, to thereby form a chamfering part 2. The angle of chamfering was set at 45 degrees, with a main surface set as a reference, and the height (length in a thickness direction of the wafer 1) and the depth (length in a diameter direction of the wafer 1) of the chamfering part 2 were set at 0.25 mm.

Regarding the edge part of the backside 1b of the wafer 1, in FIG. 1A, a chamfering part 3 was formed, with a position of 45 degrees set as a center in a counter clockwise direction from the center position of the orientation flat OF. The length L in the circumferential direction of the chamfering part 3 was set at 4 mm. Also, the angle (inclined angle) of the chamfering part 3 was set at 45 degrees, with the backside 1b set as a reference, and the height h1 and the depth d1 of the chamfering part 3 were set at 0.25 mm. A notch 4 was formed, as a mark on both end-positions of the chamfering part 3. The chamfering was not performed to the backside of the wafer, other than the part A in which the chamfering part 3 between the notches 4 and 4 was formed.

The manufactured GaAs wafer 1 was placed on the flat glass plate, and the wafer 1 was lifted by a flat tweezers having the tip end width of 2.5 mm. As a result, the tweezers could not be inserted to a place other than the part A between the notches 4 and 4, and the wafer 1 could not be lifted. Meanwhile, when the tweezers were inserted to the place A between the notches 4 and 4 having the chamfering part 3, the wafer 1 could be easily clamped and lifted.

### Example 2

An example 2 of the present invention will be described by using FIG. 2A to FIG. 2C.

FIG. 2A is a plan view of the wafer 1, being a substrate, viewed from the front side 1a, FIG. 2B is an expanded sectional view of the wafer end portion of a part other than the part A (part/are between laser marks 5 and 5) of the wafer 1 in FIG. 2A, and FIG. 2C is an expanded sectional view of the wafer end portion of the part A of the wafer 1.

First, a sapphire single crystal ingot with a diameter of 3.2 inch and a length of 250 mm was manufactured by the crystal growth from the melt liquid. After the outer periphery of this ingot was ground to set the diameter at 3 inch, the plan surface grinding was applied to a (10-10) surface, to thereby form the orientation flat OF having a width of 22 mm. Also, the plan surface grinding was applied to a (11-20) surface, to thereby form the index flat IF having the width of 12 mm. Further, after slicing the ingot by using the multi wire saw, the both surfaces of the wafer were polished, to obtain a sapphire wafer 1 having a thickness of 650 μm, with a (0001) surface set as a main surface.

Subsequently, the chamfering work was applied to the edge part on the front side 1a of this sapphire wafer 1 over the whole periphery, and the chamfering part 2 was formed. The angle of the chamfering was set at 45 degrees, with the main surface set as a reference, and the height and the depth of the chamfering part 2 is set at 0.25 mm.

Regarding the edge part of the backside 1b of the wafer 1, in the same way as the example 1, the chamfering part 3 was formed on the backside, with the position of 45 degrees set as a center, in the counter clockwise direction from a center position of the orientation flat OF. The length L in the circumferential direction of the chamfering part 3 was set at 4 mm. Also, the angle of the chamfering part 3 (inclined angle) was set at 45 degrees, with the backside 1b set as a reference, and the height h1 and the depth d1 of the chamfering part 3 were set at 0.25 mm. Laser marks 5 were formed on both end-positions of the chamfering part 3 as the marks inscribed by laser irradiation. No chamfering was performed to the wafer backside, other than the part A in which the chamfering part 3 was formed between the laser marks 5 and 5.

The manufactured sapphire wafer 1 was placed on the flat glass plate, and the wafer 1 was lifted by the flat tweezers with tip end width of 2.5 mm. As a result, the tweezers could not be inserted to a part other than the part A between the laser marks 5 and 5, and the wafer 1 could not be lifted. Meanwhile, when the tweezers were inserted to the part A between the laser marks 5 and 5 having the chamfering part 3, the wafer 1 could be easily clamped and lifted.

### Example 3

An example 3 of the present invention will be described by using FIG. 3A to FIG. 3C.

FIG. 3A is a plan view of the wafer 1, being a substrate, viewed from the front side 1a, FIG. 3B is an expanded sectional view of the wafer end portion of a part other than the part A (part/area between the laser marks 5 and 5) of the wafer 1 in FIG. 3A, and FIG. 3C is an expanded sectional view of a wafer end portion of the part A of the wafer 1 of FIG. 3A.

First, by using a hydride vapor phase epitaxy process, a GaN single crystal ingot having a length of 15 mm was manufactured. After the outer periphery of this ingot was ground to set the diameter at 3 inch, the plan-surface grinding was applied to a (10-10) surface, to thereby form the orientation flat OF having a width of 22 mm. In addition, the plan surface-grinding was applied to a (11-20) surface, and the index flat IF having a width of 12 mm was formed. Further, after slicing the ingot by using the multi wire saw, both surfaces of the wafer were polished, to obtain a GaN wafer 1 having a thickness of 650 μm, with a (0001) surface set as a main surface.

Subsequently, the chamfering work was applied to the edge part on the front side 1a of this GaN wafer 1 over the whole periphery, and the chamfering part 2 was formed. The angle of the chamfering was set at 45 degrees, with the main surface set as a reference, and the height and the depth of the chamfering part 2 were set at 0.25 mm.

Regarding the edge part of the backside 1b of the wafer 1, in the same way as the example 1, the chamfering part was formed on the backside, with the position of 45 degrees set as a center in the counter clockwise direction from the center position of the orientation flat OF. The length L in the circumferential direction of the chamfering part 3 was set at 4 mm. In addition, the angle of the chamfering part 3 was set at 45 degrees, with the backside 1b set as a reference, and the height h1 and the depth d1 of the chamfering part 3 were set at 0.25 mm. Then, the laser marks 5 were formed on both ends of the chamfering part 3 as marks.

In addition, regarding the edge part of the backside 1b, a small chamfering part 6, to which the tweezers could not be inserted, was formed in a part other than the part A formed with the chamfering part 3 between the laser marks 5 and 5. The angle of the chamfering part 6 was set at 45 degrees, with the backside 1b set as a reference, and the height h2 and the depth d2 of the chamfering part 6 were set at 0.05 mm.

The manufactured GaN wafer 1 was placed on the flat glass plate, and the wafer 1 was lifted by a flat tweezers having a tip end width of 2.5 mm. As a result, the tweezers could not be inserted to the part other than the part A between the laser marks 5 and 5, and the wafer 1 could not be lifted. Meanwhile, when the tweezers were inserted to the part A between the laser marks 5 and 5 having the chamfering part 3, the wafer 1 could be easily clamped and lifted.

### Example 4

An example 4 of the present invention will be described by using FIG. 4A to FIG. 4C.

FIG. 4A is a plan view of the wafer 1, being a substrate, viewed from the front side 1a. FIG. 4B is an expanded sectional view of the wafer end portion of a part other than the part A (part/area between the laser marks 5 and 5), and FIG. 4C is an expanded sectional view of the wafer end portion of the part A of the wafer 1.

First, the sapphire single crystal ingot having a diameter of 3.2 inch and a length of 400 mm was manufactured, by the crystal growth from the melt liquid. After the outer periphery of this ingot was ground to set the diameter at 3 inch, the plan surface grinding was applied to a (10-10) surface, and the orientation flat OF having a width of 22 mm was formed. In addition, the plan surface grinding was applied to a (11-20) surface, and the index flat IF having a width of 12 mm was formed. Further, after slicing the ingot by using the multi wire saw, both surfaces of the wafer were polished, to thereby obtain the sapphire wafer 1 having a thickness of 650 μm, with a (0001) surface set as a main surface.

Subsequently, the chamfering work was applied to the edge part on the front side 1a of this sapphire wafer 1 over the whole periphery, and the chamfering part 2 was formed. The angle of the chamfering was set at 45 degrees, with the main surface set as a reference, and the height and the depth of the chamfering part 2 were set at 0.25 mm.

Regarding the edge part of the backside 1b of the wafer 1, as shown in FIG. 4A, the chamfering part 3 was formed at two places on the backside, with the position of 45 degrees set as the center, in clockwise and counter clockwise directions from the center position of the orientation flat OF. The length L in the circumferential direction of the chamfering part 3 was set at 4 mm. In addition, the angle of the chamfering part 3 was set at 45 degrees, with the backside 1b set as a reference, and the height h1 and the depth d1 of the chamfering part 3 were set at 0.25 mm. Then, the laser marks 5 were formed on both ends of the chamfering part 3 as marks.

Moreover, regarding the edge part of the backside 1b, the small chamfering part 6, to which the tweezers could not be inserted, was formed in a part other than the part A formed with the chamfering part 3 between the laser marks 5 and 5. The angle of the chamfering part 6 was set at 45 degrees, with the backside 1b set as a reference, and the height h2 and the depth d2 of the chamfering part 6 were set at 0.05 mm.

The manufactured sapphire wafer 1 was placed on the flat glass plate, and the wafer 1 was lifted by the flat tweezers having the tip end width of 2.5 mm. As a result, the tweezers could not be inserted to the part other than the part A between the laser marks 5 and 5, and the wafer 1 could not be lifted. Meanwhile, when the tweezers were inserted to the part A between the laser marks 5 and 5 having the chamfering part 3, the wafer 1 could be easily clamped and lifted.

### Comparative Example

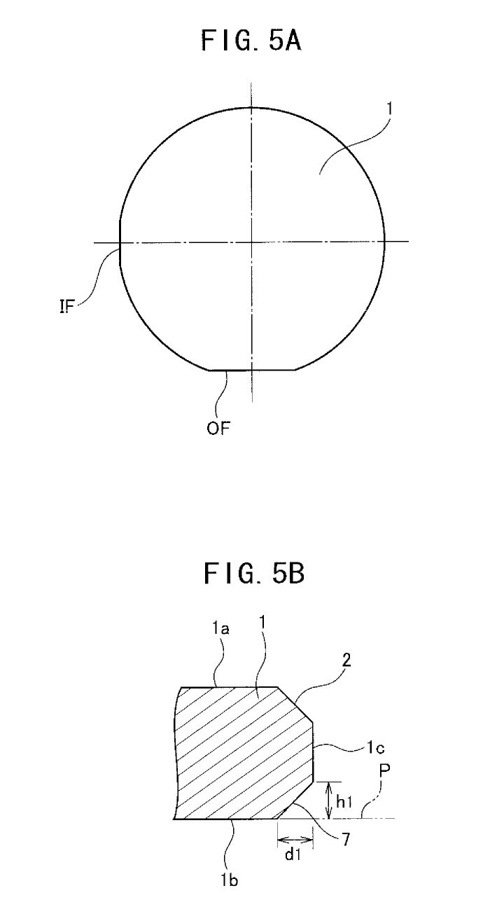

A comparative example for comparing effects of the aforementioned examples will be described by using FIG. 5A and FIG. 53.

FIG. 5A is a plan view of the wafer 1 viewed from the front side 1a. FIG. 5B is an expanded sectional view of the end portion of the wafer 1 of FIG. 5A.

First, the GaAs single crystal ingot having the diameter of 3.2 inch and a length of 250 mm was manufactured, by the crystal growth from the melt liquid. After the outer periphery of this ingot was ground to set the diameter at 3 inch, the plan surface grinding was applied to a (0-1-1) surface to form the orientation flat OF having a width of 22 mm. In addition, the plan surface grinding was applied to a (0-11) surface, to form the index flat IF having a width of 12 mm was formed. Further, after slicing the ingot by using the multi wire saw, both surfaces of the wafer were polished, to obtain the GaAs wafer 1 having a thickness of 650 μm, with a (100) surface set as a main surface.

Subsequently, the chamfering work was applied to the edge part on the front side 1a of this GaAs wafer 1 over the whole periphery, and the chamfering part 2 was formed. The angle of the chamfering was set at 45 degrees, with the main surface set as a reference, and the height and the depth of the chamfering part 2 were set at 0.25 mm.

Regarding the edge part of the backside 1b of the wafer 1, the chamfering work was applied to the whole periphery in the same way as the front side 1a. Then, the angle of the chamfering part 7 on the backside 1b was set at 45 degrees, with the backside set as a reference, and the height h1 and the depth d1 of the chamfering part 7 were set at 0.25 mm.

The manufactured GaAs wafer 1 was placed on the flat glass plate, and the wafer 1 was lifted by the flat tweezers having the tip end width of 2.5 mm. As a result, the tweezers could be inserted to an arbitrary position of the outer periphery of the wafer 1, and the wafer 1 could be easily clamped and lifted.

### Comparison of the Effects Between the Example 1 and the Comparative Example

The effects were compared, by using the GaAs wafer of the example 1, and the GaAs wafer of the comparative example. A light emitting diode structure (LED epitaxial layer) was epitaxial grown on the wafers of the example 1 and the comparative example, and the number of abnormally grown places within 10 mm was measured from the edge part of each wafer.

The epitaxial growth was performed by a MOVPE method (metal organic vapor phase Epitaxial method). First, n type (Se-doped) GaAs buffer layer, n-type (Se-doped) (Al_{0.7}Ga_{0.3})_{0.5}In_{0.5}P clad layer, undoped (Al_{0.15}Ga_{0.85})_{0.5}In_{0.5}P active layer, p-type (Zn-doped) (Al_{0.7}Ga_{0.3})_{0.5}In_{0.5}P clad layer are grown on the GaAs wafer by using the MOVPE method, and 10 μm of p-type GaP was grown thereon. The MOVPF growth up to p-type (Al_{0.7}Ga_{0.3})_{0.5}In_{0.5}P clad layer was performed, with a growing temperature set at 700 degrees, growing pressure set at 50 torr, a growing speed of each layer set at 0.3 to 1.0 nm/sec, and V/III ratio set at 200 to 400. GaP was grown, with the V/III ratio set at 50 and the growing speed set at 1 nm/sec. Zn concentration of the p-type clad layer is expressed by 5×10¹⁷ cm⁻³, and the Zn concentration of the GaP layer is expressed by 1×10¹⁸ cm⁻³.

Similar growing process was performed to 100 sheets for each of the GaAs wafers of the example 1 and the comparative example. Note that an agreement is made in the handling of the wafer by using the tweezers, so that only the position between notches 4 and 4 is clamped in the case of the wafer of the example 1, and in the case of the wafer of the comparative example, only the position of 45 degrees, being an obliquely right downward position, is clamped.

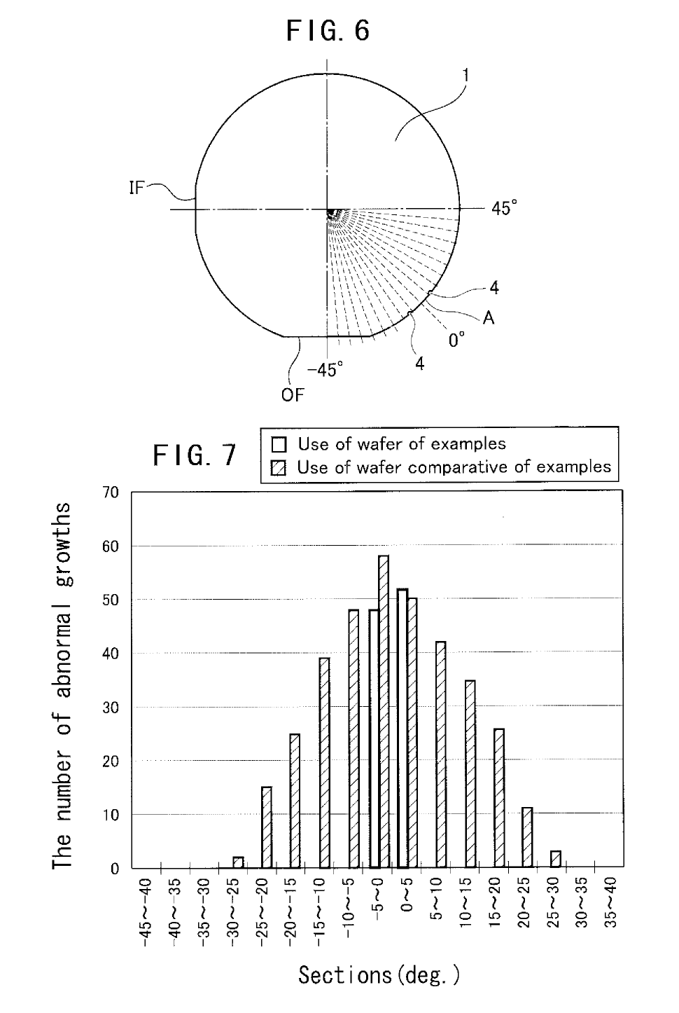

Then, the numbers of abnormal growths that appear in an area from the outermost peripheral part to 10 mm inward in the radius direction of the wafer were compared, for the epitaxial layer on the wafer manufactured by handling using the tweezers. As shown in FIG. 6, an area of 90° including the part A of the wafer 1 (area of 90° including a part where clamping was also allowed in the case of the wafer of the comparative example) was virtually divided into fan-shaped sections of 5° respectively, and counting was performed in each section. When the substrate was placed on a horizontal surface, with the orientation flat OF set on the front side, the position of 45°, being the obliquely right downward position, was set as an original point (0°). A measurement result is shown in FIG. 7.

It is found that in the wafer of the example 1, the abnormal growth occurs highly frequently only in the vicinity of the original point, while in the wafer of the comparative example, the abnormal growth occurs extending over a wider range. It can be so considered that in the case of the substrate of the example 1, an abnormal growth generation area can be limited to an extremely narrow part, because the tweezers can not be inserted to a position other than the vicinity of the original point. Meanwhile, in the case of the wafer of the comparative example, although the agreement is made so that the vicinity of the original point should be clamped, this clamping operation is performed by an operator's visual adjustment, and in addition, the tweezers can be inserted to an arbitrary place. Therefore it can be so considered that the abnormal growth occurs over the wider range.

In the above-described examples, although sectional shapes of the chamfering parts 3 and 6 on the backside are formed into linear shapes, the sectional shapes of them may be formed into curved shapes or combination of a linear shape and a curved shape. Note that the chamfering work on the front side of the water (substrate) is not particularly limited, and no chamfering may be performed or the chamfering may be performed only to a part of the outer periphery. In addition, the length and the shape of the chamfering of a substrate clamping part (clamping area) A of the backside, a setting place and setting numbers can be suitably changed in accordance with the individual condition of the process.

In addition, in the above-described example, only the single crystal wafer (substrate) is described, the examples can also be similarly applied to a polycrystalline or amorphous wafer (substrate). In this case, a principle of film formation is not limited to the epitaxial growth.

What is claimed is:

1. A substrate for epitaxial growth, wherein a chamfering part is partially formed on the backside, opposite to the front side of the substrate on which epitaxial growth is performed.

2. The substrate for epitaxial growth according to claim 1, wherein when a size of the substrate is set at x (mm), a peripheral length of the chamfering part formed on the backside of the substrate is set at 2 mm or more and 0.15x (mm) or less.

3. The substrate for epitaxial growth according to claim 1, wherein when the substrate is placed on a flat surface, with a substrate front side turned up, height of a gap formed between the chamfering part on the backside of the substrate and the flat surface is set at 0.2 mm or more.

4. The substrate for epitaxial growth according to claim 3, wherein depth of the gap is set at 0.2 mm or more.

5. The substrate for epitaxial growth according to claim 1, wherein marks are inscribed to both end-positions of the chamfering part on the backside.

6. The substrate for epitaxial growth according to claim 5, wherein the marks are notches.

7. The substrate for epitaxial growth according to claim 5, wherein the marks are laser marks.

8. A substrate for epitaxial growth, wherein chamfering parts of two or more kinds of different shapes are formed on the backside, opposite to the front side of the substrate on which epitaxial growth is performed.

9. The substrate for epitaxial growth according to claim 8, wherein when the substrate is placed on a flat surface, with a substrate front side turned up, one of the chamfering parts of two or more kinds of different shapes is a large chamfering part with height of a gap formed between the substrate and the flat surface set at 0.2 mm or more, and when a size of the substrate is set at x (mm), a peripheral length of the large chamfering part is 2 mm or more and 0.15x (mm) or less.

10. The substrate for epitaxial growth according to claim 8, wherein when the substrate is placed on the flat surface, with the substrate front side turned up, height and depth of the gap is under 0.1 mm in a peripheral part other than the large chamfering part of the substrate.

11. The substrate for epitaxial growth according to claim 8, wherein marks are inscribed to both end-positions of the large chamfering part.

12. The substrate for epitaxial growth according to claim 11, wherein the marks are notches.

13. The substrate for epitaxial growth according to claim 11, wherein the marks are laser marks.

14. A substrate for epitaxial growth, wherein an area having a plurality of different chamfering shapes is formed on the backside, opposite to the front side of the substrate on which epitaxial growth is performed.

15. The substrate for epitaxial growth according to claim 14, wherein the area of the plurality of different chamfering shapes includes a clamping area into which a clamping tool for clamping the substrate can be inserted from a gap formed between the substrate and a flat surface, when the substrate is placed on the flat surface, with the front side turned up, and a non-clamping area into which the clamping tool can be hardly inserted from the gap.

16. The substrate for epitaxial growth according to claim 15, wherein in a chamfering shape of the backside of the clamping area, height of the gap is set at 0.2 mm or more.

17. The substrate for epitaxial growth according to claim 15, wherein in the chamfering shape of the backside of the clamping area, depth of the gap is set at 0.2 mm or more.

18. The substrate for epitaxial growth according to claim 15, wherein in a chamfering shape of the backside of the non-clamping area, both of the height and depth of the gap are set at under 0.1 mm.

19. The substrate for epitaxial growth according to claims 15, wherein when the diameter of the substrate is set at x (mm), a peripheral length of the substrate of the clamping area is set at 2 mm or more and 0.15x (mm) or less.

20. The substrate for epitaxial growth according to claims 15, wherein marks of notches or laser marks are inscribed to both end-positions of the clamping area.
